(19) United States
(12) Patent Application Publication
(10) Pub. No.: US 2009/0203645 A1
(43) Pub. Date: Aug. 13, 2009

(54) Broad Spectrum Disinfecting and Sterilizing Composition

(76) Inventors: Larry Kent Hall, Easton, PA (US); Joseph Kimler, Yardville, NJ (US)

Correspondence Address: HOFFMANN & BARON, LLP, 6900 JERICHO TURNPIKE, SYOSSET, NY, 11791, US

(21) Appl. No.: 12/367,592

(22) Filed: Feb. 9, 2009

Related U.S. Application Data
(60) Provisional application No. 61/027,890, filed on Feb. 12, 2008.

(51) Int. Cl. A01N 33/12; A01P 1/00

(52) U.S. Cl. 514/63; 514/642

(57) ABSTRACT

The present invention relates to antimicrobial compositions including an aromatic dialdehyde and a quaternary ammonium compound wherein the aromatic dialdehyde is orthophthalaldehyde, isophthalaldehyde, terephthalaldehyde, or combinations thereof, and the ratio of aromatic dialdehyde to quaternary ammonium compound is from about 10:1 to about 1:5. The invention also relates to methods of treating surfaces using the antimicrobial compositions of the invention.

### CROSS-REFERENCE TO RELATED APPLICATION

This application claims the benefit of U.S. Provisional Application No. 61/027,890, filed Feb. 12, 2008, which is incorporated herein by reference.

### BACKGROUND OF THE INVENTION

The present invention relates to antimicrobial compositions, and in particular, to those solutions useful in disinfection and sterilization.

Over the years, chemical manufacturers have sought to provide broad spectrum, high-level disinfectants and sterilants that are safe for use on hard surfaces. In particular, there is a need to deliver cost-effective disinfectants in concentrated form that can be easily diluted and used in existing delivery systems to provide rapid kill of microorganisms including bacteria, fungi, viruses, and spores. The disinfectants and sterilants must retain potency when exposed to hard water and soil.

Quaternary ammonium compounds, commonly called “quats,” are known to have antimicrobial activity. As a result of their germicidal properties, quats are commonly used in disinfectants and sanitizers. However, quaternary-based disinfectants are typically considered low-level disinfectants that are ineffective against Mycobacterium tuberculosis, bacterial spores, and nonlipid viruses. In particular, high concentrations of quaternary-based disinfectants are unable to provide a complete kill of parvoviruses such as the canine parvovirus, a virus that is debilitating and often fatal in the canine population. Furthermore, quaternary-based disinfectants are typically inactivated by soil and hard water.

Monoaldehydes and dialdehydes are also known to exhibit antimicrobial activity. For example, orthophthalaldehyde (OPA), an aromatic dialdehyde, has been FDA approved for sterilization and high-level disinfection. However, OPA can require up to 32 hours to complete the sterilization process. Since OPA does not provide a 10 minute contact time claim versus certain organisms that are a standard in the disinfection field, OPA has been limited commercially to only being utilized as a cold sterilant. Additionally, OPA's efficacy and effectiveness are limited in the presence of organic soil.

French Patent No. 2,321,300 discloses the process for preparing a bactericidal composition in aqueous solution for use in the food industry. The process involves mixing a solution of at least one monoaldehyde or dialdehyde with a quaternary ammonium compound. The preferred aldehydes are formaldehyde and glutaraldehyde, and the preferred quat is alkyldimethylbenzylammonium chloride.

German Patent No. DE 26 11 957 discloses the use of aldehydes and oligohexamethylene biguanide salts with quats as disinfectants of surfaces. The salts of oligomer hexamethylene biguanides are required to increase the persistence, i.e., residual effect, of the disinfectant. The preferred actives are formaldehyde, glyoxal, glutaraldehyde, and alkyldimethylbenzylammonium chloride.

U.S. Pat. No. 4,661,523 to Disch, et al. is concerned with the corrosive behavior of the disinfectant solutions disclosed in DE 26 11 957. The corrosion properties of known mixtures of quats and aldehydes is reduced by the addition of at least one phosphonocarboxylic acid and then adjusting the pH to 3.5 to 4.

U.S. Pat. No. 3,282,775 to Stonehill disclose sterilization compositions containing saturated dialdehydes containing two to six carbon atoms and cationic surface agents including quats. The preferred saturated dialdehyde is glutaraldehyde.

U.S. Pat. No. 5,124,359 to Wachman, et al. disclose a sterilant including at least one quaternary ammonium compound, at least one aliphatic dialdehyde having from two to six carbon atoms, and at least one aliphatic hydroxyl compound having from one to eight carbon atoms. Wachman, et al. disclose that certain aromatic dialdehydes such as pyridazine-4,5-dicarbaldehyde may also be used. The use of OPA (or its isomers) is not disclosed. Furthermore, Wachman, et al. require alkanols to improve the solubility of the solutes in the sterilant.

U.S. Pat. No. 4,971,999 to Bruckner, et al. disclose the use of phthalaldehyde as a disinfectant in aqueous solution having a pH between 3 to 9. Bruckner, et al. disclose solutions whereby the use dilution of phthalaldehyde is 0.05% to 0.5% by weight. However, Bruckner, et al. teach that the amount of phthalaldehyde used in a concentrated solution is limited by its solubility in water, which is about 5% by weight, and require compositions with phthalaldehyde greater than 5% by weight to achieve a water miscible solvent.

U.S. Pat. No. 5,936,001 to Block discloses a disinfecting and sterilizing concentrate containing an aromatic dialdehyde in a concentration greater than 5% by weight, a water-miscible solvent, and a pH buffering salt. The preferred aromatic dialdehyde is OPA. Block disclose that the pH buffering salt and water-miscible solvents are required to stabilize concentrated aromatic dialdehyde solutions. Additionally, Block recommends the use of a stabilizer to protect the pH buffering salt from the harmful effects of the water-miscible solvent.

While many broad-spectrum disinfectants and sterilants are known, there remains a need for cost-effective, disinfectants and sterilants to stop the spread of antibiotic resistant organisms and nosocomial infections.

### SUMMARY OF THE INVENTION

The present invention includes antimicrobial compositions having an aromatic dialdehyde and a quaternary ammonium compound wherein the aromatic dialdehyde is orthophthalaldehyde (OPA), isophthalaldehyde, terephthalaldehyde, or combinations thereof, and the ratio of aromatic dialdehyde to quaternary ammonium compound is from about 10:1 to about 1:5. In a preferred embodiment, the ratio of aromatic dialdehyde to quaternary ammonium compound is from about 10:1 to about 1:3.

The quaternary ammonium compound is preferably selected from the group consisting of silicone quaternaries, polyquaternaries, Gemini surfactants, a benzethonium halide, a cetalkonium halide, cetrimide, a cetrimonium halide, a cetylpyridinium halide, a glycidyltrimethylammonium halide, a stearalkonium halide, didecyldimethylammonium bicarbonate/carbonate, a didecyldimethylammonium halide, an alkyldimethylbenzylammonium halide, and combinations thereof. Most preferably, the quaternary ammonium compound is didecyldimethylammonium bicarbonate/carbonate, a didecyldimethylammonium halide, or an alkyldimethylbenzylammonium halide.

In one embodiment, the aromatic dialdehyde is present in an amount not greater than about 30% by weight of the composition, while in another embodiment, the aromatic dialdehyde is present in an amount not greater than about 20% by weight of the composition. In yet another embodiment, the aromatic dialdehyde is present in an amount not greater than about 10% by weight of the composition, and in yet another preferred embodiment, the aromatic dialdehyde is present in an amount not greater than about 1% by weight of the composition.

In one embodiment, the quaternary ammonium compound is present in an amount not greater than about 60% by weight of the composition, while in another embodiment, the quaternary ammonium compound is present in an amount not greater than about 40% by weight of the composition. In yet another embodiment, the quaternary ammonium compound is present in an amount not greater than about 20% by weight of the composition, and in another preferred embodiment, the quaternary ammonium compound is present in an amount not greater than about 10% by weight of the composition. In yet another embodiment, the quaternary ammonium compound is present in an amount not greater than about 1% by weight of the composition.

Another aspect of the invention includes an antimicrobial composition which has an aromatic dialdehyde and a quaternary ammonium compound, wherein the aromatic dialdehyde is OPA, isophthalaldehyde, terephthalaldehyde, or combinations thereof; the quaternary ammonium compound is didecyldimethylammonium bicarbonate/carbonate; and the ratio of aromatic dialdehyde to quaternary ammonium compound is from about 10:1 to about 1:5. In a preferred embodiment, the ratio of aromatic dialdehyde to quaternary ammonium compound is from about 10:1 to about 1:3. In another preferred embodiment, the antimicrobial composition can be made in the absence of required solvents, stabilizers, and buffers. In yet another preferred embodiment, the antimicrobial composition can be made in the absence of solvents, stabilizers, and buffers.

The invention also includes a method of treating a surface by contacting a surface with an effective amount of an antimicrobial composition including an aromatic dialdehyde and a quaternary ammonium compound wherein the aromatic dialdehyde is OPA, isophthalaldehyde, terephthalaldehyde, or combinations thereof, and the ratio of aromatic dialdehyde to quaternary ammonium compound is from about 10:1 to about 1:5. In a preferred embodiment, the ratio of aromatic dialdehyde to quaternary ammonium compound is from about 10:1 to about 1:3.

In the method, the quaternary ammonium compound is preferably selected from the group consisting of silicone quaternaries, polyquaternaries, Gemini surfactants, a benzethonium halide, a cetalkonium halide, cetrimide, a cetrimonium halide, a cetylpyridinium halide, a glycidyltrimethylammonium halide, a stearalkonium halide, didecyldimethylammonium bicarbonate/carbonate, a didecyldimethylammonium halide, an alkyldimethylbenzylammonium halide, and combinations thereof. Most preferably, the quaternary ammonium compound is didecyldimethylammonium bicarbonate/carbonate, a didecyldimethylammonium halide, or an alkyldimethylbenzylammonium halide.

In one embodiment, the method includes treating the surface for a time sufficient to effect disinfection. The time sufficient to effect disinfection can be at least about 1 minute, in another embodiment at least about 5 minutes, and in yet another embodiment at least about 10 minutes.

The disinfection may take place is the presence of soil, hard water, serum, or combinations thereof.

In another embodiment, the method includes treating the surface for a time sufficient to effect sterilization. The time sufficient to effect sterilization can be significantly reduced. For example, the sterilization time is preferably 16 hours, more preferably 8 hours, and most preferably 4 hours.

As a result of present invention, an antimicrobial composition is provided which can be engineered to be used in multiple roles, e.g., as a sterilant or a disinfectant, depending upon the level of dilution of the composition. The antimicrobial composition can function as a high level disinfectant or sterilant that can be used on hard surfaces to rapidly kill pathogenic organisms in the presence of soil, serum, and hard water. In particular, kill times of Mycobacterium tuberculosis are drastically reduced even in the presence of soil.

It has been discovered that the combination of the aromatic dialdehydes and quats of the invention unexpectedly exhibit synergistic behavior with regard to efficacy and speed of kill of microorganisms. For example, the speed of kill of microorganisms by OPA is significantly enhanced. Moreover, the composition of the invention effectively kills Pseudomonas aeruginosa in as little as one minute in the presence of 5% soil and 400 ppm hard water at concentrations in which OPA alone would not be effective, e.g., 1000 ppm.

Another advantage of the present invention is that high concentrations of didecyldimethylammonium bicarbonate/carbonate (DDABC) can be used in the composition without the need for any solvents, stabilizers, or buffers to increase OPA's solubility. When DDABC is used as the quaternary compound in the composition, the solubility of the aromatic dialdehydes greatly increases in aqueous solution. Consequently, highly concentrated disinfectants and sterilants can be formulated without the use of solvents which can be toxic and contribute to Volatile organic compounds (VOCs) entering the atmosphere, without pH adjustment for optimum efficacy, and without additional stabilizers.

The ability to produce a highly concentrated antimicrobial composition greatly diminishes transportation and packaging costs and promotes greater flexibility in the use of existing delivery systems in hospitals, rest homes, restaurants, food plants, and other locations where routine disinfection is practiced.

For a better understanding of the present invention, together with other and further advantages, reference is made to the following detailed description, and its scope will be pointed out in the claims.

### DETAILED DESCRIPTION

### Antimicrobial Compositions

The antimicrobial compositions of the invention include an aromatic dialdehyde and a quat. The aromatic dialdehyde is orthophthalaldehyde (OPA), isophthalaldehyde, terephthalaldehyde, or combinations thereof. The structures of the phthalaldehyde isomers are shown below:

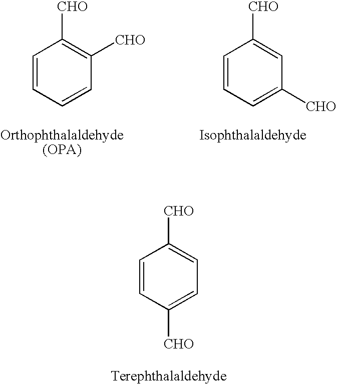

The preferred aromatic dialdehyde is OPA.

The quats useful in the invention exhibit antimicrobial properties. A single quat or a blend of quats may be used in the composition. The quats may contain aliphatic and/or aromatic moieties. Additionally, the quats may contain one or more quaternary ammonium groups within a molecule. For example, the quat may be a polyquaternary such as a Gemini surfactant, i.e., a quat containing two quaternary ammonium groups.

Although quaternary ammonium salts are preferred, cationic phosphonium, or sulfonium, or any other positive nonmetallic nuclei may be selected. Silicone quaternary ammonium compounds may also be used.

Examples of quats useful in the invention include, but are not limited to, an alkyldimethylbenzylammonium halide, a didecyldimethylammonium halide, didecyldimethylammonium bicarbonate/carbonate, a benzethonium halide, a cetalkonium halide, cetrimide, a cetrimonium halide, a cetylpyridinium halide, a glycidyltrimethylammonium halide, a stearalkonium halide, and combinations thereof. Preferably, the quat is an alkyldimethylbenzylammonium halide, a didecyldimethylammonium halide, didecyldimethylammonium bicarbonate/carbonate, or combinations thereof.

The preferred counter ions for the quaternary ammonium salts are halides, especially chloride and bromide, and carbonate/bicarbonate. The most preferred counter ion is carbonate/bicarbonate.

The optimal ratio of aromatic dialdehyde to quaternary ammonium in the composition depends upon factors such as the specific microorganisms to be targeted, the use of the composition as a disinfectant or a sterilizer, the cost of the composition, and the solubility of the actives. The ratio of aromatic dialdehyde to quaternary ammonium compound is preferably from about 10:1 to about 1:5, more preferably from about 10:1 to about 1:3. For example, if the composition contains 20% OPA and 40% DDABC by weight, then the ratio of aromatic dialdehyde to quaternary ammonium compound is 1:2.

The maximum concentration of the aromatic dialdehyde in the composition is not greater than about 30% by weight of the composition. The maximum concentration of quat is preferably not greater than about 60% by weight of the composition.

Antimicrobial compositions according to the invention may contain high concentrations of DDABC and OPA without the addition of solvents, stabilizers, or buffers. For example, a stable composition according to the invention can be made that only contains 40% DDABC, 20% OPA, and 40% water.

In the present invention, the term “in the absence of required solvents, stabilizers, and buffers” means that no solvents, stabilizers, or buffers are necessary in the compositions to obtain a stable formula wherein the active ingredients are completely dissolved. However, the term also implies that solvents, stabilizers, and buffers can be used in the composition.

The antimicrobial concentrate may be diluted to any strength necessary to effect the desired level of antimicrobial activity. For example, the antimicrobial compositions of the present invention can be used as disinfectants or stabilizers based upon the concentration of the active ingredients. The level of dilution depends upon factors such as the specific microorganisms to be targeted, whether the composition will be used on a clean or dirty, i.e., contaminated by soil, serum, etc., surface, the desired kill time, and the level of decontamination required. The level of dilution can be determined by one of ordinary skill in the art.

### Antimicrobial Activity

The compositions according to the invention demonstrate antimicrobial properties. In this specification, antimicrobial properties refer to the ability to destroy and/or resist growth of bacteria, fungi, viruses, spores, algae, yeast, and mold.

Depending upon the concentration of the actives, the compositions of the invention may be classified by the FDA as sterilants, e.g., chemical compounds which destroy all microorganisms including bacterial spores. At lower concentrations, the compositions of the invention may be classified by the EPA as high-level disinfectants, e.g., chemical compounds which destroy all microorganisms, but not necessarily high numbers of bacterial spores.

The antimicrobial composition according to the invention is broad-spectrum, i.e., it is active against both gram positive and gram negative bacteria. Some examples of Gram positive bacteria include, for example, Bacillus cereus, Micrococcus luteus, and Staphylococus aureus. Some examples of Gram negative bacteria include, for example, Escherichia coli, Enterobacter aerogenes, Enterobacter cloacae, Pseudomonas aeruginosa, and Proteus vulgaris.

The compositions of the invention have been found to be particularly useful in rapidly destroying Mycobacterium tuberculosis and parvoviruses. See the Examples section below.

### Method of Treating a Surface

Another aspect of the invention relates to a method of treating a surface by contacting the surface with an effective amount of an antimicrobial composition of the invention. The surface may be any hard surface that requires treatment with an antimicrobial composition.

Some examples of surfaces include, but are not limited to, hospital floors, walls, tabletops, countertops, bed rails, door knobs, light switches, toilets, and medical equipment such as thermometers, blood pressure cuffs, scissors, scalpels, and endoscopes.

The antimicrobial composition may be in contact with the surface for a sufficient time to effect disinfection or sterilization. Typically, sterilization requires exposure to the antimicrobial composition for a longer time than disinfection does. As discussed above, sterilization also requires a higher concentration of active ingredient than disinfection. The time of contact to effect disinfection or sterilization and the appropriate concentration of active ingredients in the composition can be determined by one of ordinary skill in the art.

The method of treating the surface may also take place in the presence of organic soil, hard water, and serum.

The present invention may be better understood by reference to the following examples. The following examples illustrate the present invention and are not intended to limit the invention or its scope in any manner.

### EXAMPLES

### Example 1

### Bacterial Testing

Bacteria (gram negative): Pseudomonas aeruginosa

Pathogenesis: Opportunistic pathogen in humans, cause of 1 in 10 nosocomial infections¹, causes wound, blood, burn, urinary tract, lung and ear infections. ¹http://textbookofbacteriology.net/pseudomonas.html

Concentration of Bacteria: 6.81 log₁₀ (CFU/g)

Solution Contact Time: 1 minute

Dilution media: hard water (400 ppm)

Bio burden: 5% organic soil

The tests were performed using the ISO-GRID™ membrane filter system (Neogen Corp., Lansing, Mich., USA) according to a slightly modified procedure described in the ISO-GRID™ Methods Manual (3^{rd} Ed.; QA Life Sciences, Inc., San Diego, Calif., USA; 1999). The test results are compiled in Table 1 below.

TABLE 1

| | OPAⁱ | DDABCⁱⁱ | Results |
|---|---|---|---|
| | Concentration | Concentration | Log₁₀ Reduction |
| Sample No. | (ppm) | (ppm) | (percent kill)² |
| 1 | 1000 | 700 | 6.81 (100%) |
| 2 | 1000 | 500 | 6.81 (100%) |
| 3 | 0 | 700 | 5.95 (87.4%) |
| 4 | 1000 | 0 | 2.74 (40.2%) |

ⁱOrthophthalaldehyde
ⁱⁱDidecyldimethylammonium bicarbonate/carbonate
²(log₁₀ reduction/log₁₀ starting concentration) × 100%

The combination of OPA and DDABC resulted in complete kill of the gram-negative Pseudomonas aeruginosa bacteria. Neither OPA nor DDABC alone were sufficient to kill all of the Pseudomonas aeruginosa.

### Example 2

### Virus Testing

Virus: Canine parvovirus.

Pathogenesis: Severe debilitating and often fatal virus of dogs, especially puppies. It attacks cardiac and intestinal tissue causing heart failure and sepsis.

Concentration: See AOAC Use Dilution Test procedure³ ³http://www.epa.gov/oppbead1/methods/atmpmethods/MB-05-04.pdf

Dilution media: hard water (400 ppm)

Bio burden: 5% organic soil

TABLE 2

| Sample | 59% OPAⁱ/41% DDABCⁱⁱ | 60% DDACⁱⁱⁱ/40% | |
|---|---|---|---|
| No. | (ppm) | ADBAC^{iv} (ppm) | Result |
| 1 | 1700 | 0 | Pass |
| 2 | 0 | 6800 | Fail |

ⁱOrthophthalaldehyde
ⁱⁱDidecyldimethylammonium bicarbonate/carbonate
ⁱⁱⁱDidecyldimethylammonium chloride
^{iv}Alkyldimethylbenzylammonium chloride

As demonstrated in Table 2, quats alone are incapable of killing parvovirus, even at levels of 6800 ppm. However, the composition according to the invention, i.e., the 59% OPA/41% DDABC mix, is sufficient to provide complete kill of the parvovirus.

### Example 3

### Mycobacterium

Bacteria (neither gram negative nor gram positive⁴): Mycobacterium bovis ⁴http://www.biohealthbase.org/GSearchMycobacterium_Organismjsp?decorator=Mycobacterium

Pathogenesis: Cause of tuberculosis in cattle and occasionally in humans. M. bovis is often utilized in testing as a substitute for the human pathogen, Mycobacterium tuberculosis.

Concentration: 5.8* 10⁵ CFU/carrier. See AOAC Tuberculocidal Activity of Disinfectant Test^{5,6} ⁵http://www.epa.gov/oppbead1/methods/atmpmethods/MB-02-03 .pdf⁶http://www.epa.gov/oppad001/dis_tss_docs/dis-06.htm

Contact time: Ten minutes

Bio burden: 5% fetal bovine serum

TABLE 3

| | | | Results | Pass/Fail |
|---|---|---|---|---|
| | | | (Intermediate | (Intermediate |
| Sample No. | % DDABCⁱ | % OPAⁱⁱ | 30 day read) | 30 day read) |
| 1. | 2.0 | 0 | 1/10 | Fail |
| 2. | 0 | 0.5 | 1/10 | Fail |
| 3. | 2.0 | 0.5 | 0/10 | Pass |
| 4. | 1.0 | 0.5 | 0/10 | Pass |

ⁱdidecyldimethylammonium bicarbonate/carbonate
ⁱⁱOrthophthalaldehyde

Mycobacterium bovis, often used as a test substitute for the human pathogen Mycobacterium tuberculosis, is completely killed by the composition of the invention. However, neither OPA, nor DDABC alone was sufficient to provide complete kill.

Thus, while there have been described what are presently believed to be the preferred embodiments of the present invention, those skilled in the art will appreciate other and further changes and modifications thereto, and it is intended to include such other changes as come with the scope of the invention as set forth in the following claims.

We claim:

1 An antimicrobial composition comprising:
an aromatic dialdehyde and a quaternary ammonium compound wherein;
i) the aromatic dialdehyde is selected from the group consisting of orthophthalaldehyde, isophthalaldehyde, terephthalaldehyde, and combinations thereof; and
ii) the ratio of aromatic dialdehyde to quaternary ammonium compound is from about 10:1 to about 1:5.

2. An antimicrobial composition according to claim 1, wherein the ratio of aromatic dialdehyde to quaternary ammonium compound is from about 10:1 to about 1:3.

3. An antimicrobial composition according to claim 1, wherein the aromatic dialdehyde is orthophthalaldehyde.

4. An antimicrobial composition according to claim 1, wherein the aromatic dialdehyde is isophthalaldehyde.

5. An antimicrobial composition according to claim 1, wherein the aromatic dialdehyde is terephthalaldehyde.

6. An antimicrobial composition according to claim 1, wherein the quaternary ammonium compound is selected from the group consisting of silicone quaternaries, polyquaternaries, Gemini surfactants, a benzethonium halide, a cetalkonium halide, cetrimide, a cetrimonium halide, a cetylpyridinium halide, a glycidyltrimethylammonium halide, a stearalkonium halide, didecyldimethylammonium bicarbonate/carbonate, a didecyldimethylammonium halide, an alkyldimethylbenzylammonium halide, and combinations thereof.

7. An antimicrobial composition according to claim 6, wherein said quaternary ammonium compound is didecyldimethylammonium bicarbonate/carbonate.

8. An antimicrobial composition according to claim 6, wherein said quaternary ammonium compound is a didecyldimethylammonium halide.

9. An antimicrobial composition according to claim 6, wherein said quaternary ammonium compound is an alkyldimethylbenzylammonium halide.

10. An antimicrobial composition according to claim 1, wherein the aromatic dialdehyde is present in an amount not greater than about 30% by weight of the composition.

11. An antimicrobial composition according to claim 1, wherein the aromatic dialdehyde is present in an amount not greater than about 20% by weight of the composition.

12. An antimicrobial composition according to claim 1, wherein the aromatic dialdehyde is present in an amount not greater than about 10% by weight of the composition.

13. An antimicrobial composition according to claim 1, wherein the aromatic dialdehyde is present in an amount not greater than about 1% by weight of the composition.

14. An antimicrobial composition according to claim 1, wherein said quaternary ammonium compound is present in an amount not greater than about 60% by weight of the composition.

15. An antimicrobial composition according to claim 1, wherein said quaternary ammonium compound is present in an amount not greater than about 40% by weight of the composition.

16. An antimicrobial composition according to claim 1, wherein said quaternary ammonium compound is present in an amount not greater than about 20% by weight of the composition.

17. An antimicrobial composition according to claim 1, wherein said quaternary ammonium compound is present in an amount not greater than about 10% by weight of the composition.

18. An antimicrobial composition according to claim 1, wherein said quaternary ammonium compound is present in an amount not greater than about 1% by weight of the composition.

19. An antimicrobial composition comprising:
an aromatic dialdehyde and a quaternary ammonium compound wherein;
i) the aromatic dialdehyde is selected from the group consisting of orthophthalaldehyde, isophthalaldehyde, terephthalaldehyde, and combinations thereof,
ii) the quaternary ammonium compound is didecyldimethylammonium bicarbonate/carbonate; and
ii) the ratio of aromatic dialdehyde to quaternary ammonium compound is from about 10:1 to about 1:5.

20. An antimicrobial composition according to claim 19, wherein the ratio of aromatic dialdehyde to quaternary ammonium compound is from about 10:1 to about 1:3.

21. An antimicrobial composition according to claim 19, in the absence of required solvents, stabilizers, and buffers.

22. An antimicrobial composition according to claim 19, in the absence of solvents, stabilizers, and buffers.

23. A method of treating a surface comprising:
contacting said surface with an effective amount of an antimicrobial composition said antimicrobial composition comprising an aromatic dialdehyde and a quaternary ammonium compound wherein;
i) the aromatic dialdehyde is selected from the group consisting of orthophthalaldehyde, isophthalaldehyde, terephthalaldehyde, and combinations thereof, and
ii) the ratio of aromatic dialdehyde to quaternary ammonium compound is from about 10:1 to about 1:5.

24. A method according to claim 23, wherein the ratio of aromatic dialdehyde to quaternary ammonium compound is from about 10:1 to about 1:3.

25. A method according to claim 23, wherein the quaternary ammonium compound is selected from the group consisting of silicone quaternaries, polyquaternaries, Gemini surfactants, a benzethonium halide, a cetalkonium halide, cetrimide, a cetrimonium halide, a cetylpyridinium halide, a glycidyltrimethylammonium halide, a stearalkonium halide, didecyldimethylammonium bicarbonate/carbonate, a didecyldimethylammonium halide, an alkyldimethylbenzylammonium halide, and combinations thereof.

26. A method according to claim 23, wherein said treating a surface is for a time sufficient to effect disinfection.

27. A method according to claim 26, wherein said time sufficient to effect disinfection is at least about 1 minute.

28. A method according to claim 26, wherein said time sufficient to effect disinfection is at least about 5 minutes.

29. A method according to claim 26, wherein said time sufficient to effect disinfection is at least about 10 minutes.

30. A method according to claim 26, wherein said disinfecting takes place in the presence of soil, hard water, serum, and combinations thereof.

31. A method according to claim 23, wherein said treating a surface is for a time sufficient to effect sterilization.

32. A method according to claim 31, wherein said time sufficient to effect sterilization is at least about 16 hours.

33. A method according to claim 31, wherein said time sufficient to effect sterilization is at least about 8 hours.

34. A method according to claim 31, wherein said time sufficient to effect sterilization is at least about 4 hours.
